(19) United States
(12) Patent Application Publication
(10) Pub. No.: US 2003/0007167 A1
(43) Pub. Date: Jan. 9, 2003

(54) Seamless multi-page spreads

(76) Inventors: Jeremy C. Catt, Windham, NH (US); Jeanne Lucivero, Burlington, MA (US); Lisa Chambers, Medford, MA (US); Donna Groebe, Burlington, MA (US)

Correspondence Address: AGFA CORPORATION, LAW & PATENT DEPARTMENT, 200 BALLARDVALE STREET, WILMINGTON, MA, 01887, US

(21) Appl. No.: 09/898,902

(22) Filed: Jul. 3, 2001

(51) Int. Cl. G06F 15/00; B41J 1/00

(52) U.S. Cl. 358/1.12

(57) ABSTRACT

A print drive is present in an electronic pre-press workflow that includes a raster image processor (“RIP”) and an output device to receive, store, combine and transmit raster data of individual pages and multi-page spreads processed by the raster image processor. Multi-page spread raster data is processed by the raster image processor as a single file. A prepress imposition scheme is created at the front end and processed by the RIP. Prepress imposition parameters are used to generate a press sheet template image, which is transmitted to the print drive. The print drive is capable of modifying the press sheet to accommodate the multi-page spread raster data, and applying the press sheet template to raster data of individual pages and multi-page spreads on demand to form a press-sheet assembly so that raster images of individual pages and spreads remain independent.

### CROSS-REFERENCE TO RELATED APPLICATIONS

This application is related to a co-pending U.S. patent application, identified by Attorney Docket No. XP-0912, entitled “Just-In-Time Raster Image Page Assembly”, filed on May 16, 2001, by Catt et al., which is incorporated herein by reference.

### TECHNICAL FIELD

The invention relates to enhancing workflow in electronic prepress and imagesetting systems. More particularly, the invention is directed towards automated systems and methods for optimizing the prepress processing of print jobs containing multi-page spreads.

### BACKGROUND INFORMATION

Magazines typically feature a center or cover spread, where images or textual materials in the middle or on the cover of the magazine are continued across two facing pages. Similarly, folding brochures and flyers may have images or text spreading across the number of folds.

In the prepress system of the prior art, page images, including multi-page spreads, are designed on front end computers (“front end”). A multi-page spread may be designed as a combination of two or more pages with one or more images 15 spreading across the pages 11-12, as shown on FIG. 1A, or simply comprise a single image 25 the size of two or more pages 21-22, as shown on FIG. 1B.

Various front-end software application programs produce output in a page description language. Page description languages, such as Postscript™ and PDF™, offered by Adobe Systems of Mountain View, Calif., allow text descriptions of large image data files to be transferred efficiently over communication lines and data networks.

Referring to FIG. 2, as known in the art of electronic prepress systems, output devices, such as imagesetters and platesetters, and, more recently, direct on-press imaging systems, have been served by a dedicated raster image processor 34 (“RIP”) connected between front end 40 and an output device 46.

Page description language code is generally significantly smaller in data size than the raster data that results from the interpreted page description language code. When a page description language image file data is received by the RIP, operations such as font processing, image placement, trapping, and color separating result in a final output file, which is configured for a proofer 68, which is used to view images on paper in a simulation of the final, printed product, or another output device 46.

Recent use of large-format imagesetters and platesetters goes well beyond creation of single pages. These output devices produce press size “flats” or “press sheets” in film or plate that contain four, eight, or more pages. After printing on a press, the press sheet is then cut and folded to become part of a paper document, such as a book or a magazine. The process of grouping the pages into a press sheet is called imposition. Imposition may require some adjustments to be made to the image files to compensate for shifts that occur on the press when individual pages are printed together as a press sheet.

Prepress imposition design of the press sheet is traditionally performed at the front end 40 using imposition application software. Prepress operators use imposition application software to electronically position individual pages coded in a page description language, such as PostScript or PDF, onto an electronic representation of a press sheet to form a flat 95, i.e. a multi-page press sheet image. The exact page order depends on the number of pages on the press sheet. To accomplish the layout, the imposition software combines the page description language data of individual pages into a single page description language file and then adds cutting, folding, and other custom flat marks, thereby creating a fully-imposed flat 95.

In addition to placing pages in the correct position and order, the imposition software compensates for the behavior of paper when it is folded. These adjustments are particularly important when the number of pages in a final product is large or when the pages are printed on heavy stock. Two principal adjustments involve slightly moving the page image on the press sheet. Bottling compensates for the fact that pages skew when the print job is folded because of the thickness of the paper. To counteract the shift, the page image is slightly skewed in the opposite direction

As shown on FIG. 3, shingling 30 is an adjustment that compensates for the tendency of the pages in a saddle-stitched, or, to a lesser degree, perfect-bound, book or magazine to push out (“creep”) towards the outside of the book. Once a publication has been trimmed to even out the outside edge, however, the pages closer to the center are narrower than the outer pages. To compensate for this, the content of the pages is gradually moved towards the spine. The amount of shingling 30 needed is the greatest in the center pages of a book and the least in those nearest to the covers.

Commercially available imposition software packages, such as Preps™ available from ScenicSoft™ of Linwood, Wash., allow imposing large publications, consisting, for example, of 24 or 48 pages, using standard two-sided 8-, 16- or 32-page templates. The imposition software automatically calculates the appropriate imposition parameters, including necessary adjustments, such as bottling and shingling, to create a document containing a predetermined number of pages.

Referring back to FIG. 2, the flat 95 is transmitted to the RIP 34 for processing as a single bitmap image file to prepare a file for transfer to the output device. It is, thus, necessary to have all individual pages of the print job available prior to RIP-processing.

The page description language code that must be interpreted to image multiple pages in one press sheet is very complex, and the resulting bitmaps are very large. As a result, the RIP may be a bottleneck in creating press sheet films and plates. RIP-processing time for complex images can require several multiples of the imaging time.

This method is inefficient and time-consuming, because a change in even a part of one page of the flat generally requires that the RIP reprocess the entire flat. In addition, the processing of a single raster image is further complicated by the necessity of processing all of the page image data at the same time. The page description language code that must be interpreted to image multiple pages and spreads onto a single press sheet is very complex, and the resulting bitmaps are very large. As a result, RIP-processing time for complex images can be much slower than the processing of individual pages separately. The bottleneck of slow RIP speeds affects the workflow both the first time the flat 95 is processed by the RIP and then each time when a modified version of the flat is processed.

Moreover, if a magazine to be printed contains, for example, a two-page center spread, in order to impose it as a single two-page image, the prepress operator will need to create a custom imposition template, thereby foregoing the benefits of an automatic setup of a number of imposition parameters available in a standard template. This may be impractical, because some of the imposition parameters, like shingling adjustment, are extremely difficult to setup manually. It is, thus, preferred to impose each page of the center or cover spread of the magazine or each fold of the brochure separately. To accomplish that, it may be necessary for an operator of the prepress imaging system to manually divide the spread into separate pages or folds. This may become inconvenient and time-consuming to the operator as well, especially when the spread was initially designed as a single image. Referring to FIG. 1B, positioning of the dotted line 23 dividing the image 25 into component pages 21 and 22 has to be determined manually by the operator.

### SUMMARY OF THE INVENTION

An object of the present invention is to provide a practical method for imaging, which enhances system productivity and flexibility. A print drive is electronically connected between a RIP and one or more destination devices, and includes an output subsystem to receive, store, combine and transmit raster data processed by the RIP. A prepress imposition scheme is created at the front end and processed by the RIP. Prepress imposition parameters are used to generate a press sheet template image, which is transmitted to the print drive. The print drive is capable of applying the press sheet template to page raster data on demand to form a press sheet assembly so that raster images of individual pages remain independent. Among other benefits, this improves electronic prepress workflow by eliminating the need to have all individual pages of the print job available prior to RIP-processing or to generate combined raster images of multi-page press sheets to correct or modify a portion of the assembly.

As discussed above, however, imposing pages of different sizes can be impractical, because it prevents an automatic setup of a number of imposition parameters. Further, it is undesirable to impose and RIP-process each page of the center or cover spread of the magazine or each fold of the brochure separately. Aside from the inconvenience of having to divide a single image spread into separate pages, separate imposition and RIP-processing may also impair the quality of the output. If two pages that comprise the center or cover spread of a magazine, or multiple folds of a brochure, are RIP-processed separately, the screens, used to create the image as dots of ink on the press sheet, become discontinuous between the two pages or folds, which may cause a defect in the final output. Referring to FIG. 4., a visible line 114, caused by the break between the screens, appears between component pages 11-12 of the spread.

Accordingly, it is a particular object of the present invention to provide fully imposed press sheets, which contain individual pages and multi-page spreads, at output time without creating cumbersome press sheet raster image files and without compromising the quality of final output.

In general, in one aspect, the invention features a method for imaging. The method includes receiving multi-page spread raster data of at least one of the multi-page spreads of a print job, where the multi-page spread raster data is processed by the raster image processor as a single file. The method further includes receiving a press sheet template, which consists of prepress imposition data, modifying the press sheet template to accommodate the multi-page spread raster data; and then on demand digitally applying the press sheet template to the multi-page spread raster data to form a press sheet assembly.

The prepress imposition data may consist of position, sequencing, orientation, bleeds, and offset parameters for at least one page to be positioned on a press sheet and may also consist of press sheet imposition parameters. In one embodiment, the method further consists of receiving prepress imposition data from an imposition generator, extracting the position, sequencing, orientation, bleeds, and offset parameters, and the press sheet imposition parameters from the prepress imposition data, and producing the press sheet template from the prepress imposition data.

In one embodiment of the invention, the step of modifying the press sheet template consists of modifying the position, bleeds and offset parameters for the predetermined number of adjacent pages. The predetermined number of adjacent pages may equal the number of pages of at least one of the multi-page spreads.

In still another embodiment, the method also includes rendering the press sheet assembly to a destination device. The destination device may be a platesetter for imaging onto a plate, an imagesetter for imaging onto photosensitive paper and film, a printer for imaging onto paper, a storage medium for storing a file, or a press for direct on-press imaging.

In general, in yet another aspect, the invention features a print drive. The print drive includes an input subsystem for receiving multi-page spread raster data of at least one of the spreads of a print job and for receiving a press sheet template. The print drive may also include a data store for storing press sheet templates. The print drive also includes a digital press sheet modifier in communication with the input subsystem and the data store. The digital press sheet modifier modifies the press sheet template to accommodate the multi-page spread raster data by modifying the position, bleeds and offset parameters for the predetermined number of adjacent pages. The print drive also includes a digital press sheet assembler, which operates to digitally apply the modified press sheet template to the raster data of individual pages and multi-page spreads on demand to form a press sheet assembly. The modifier and the assembler may include a user interface. The user interface enables the system operator to view and modify the imposition templates, as well as to apply the templates to the raster data of individual pages and multi-page spreads.

In general, in still another aspect, the invention features an imaging system consisting of a page generator for creating at least one of the multi-page spread files of a print job, an imposition generator for creating prepress imposition data, a raster image processor for processing the spread file to produce the multi-page spread raster data, as well as for processing prepress imposition data to produce a press sheet template, and a print drive in communication with the raster image processor.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIGS. 1A and 1B show examples of multi-page spreads;

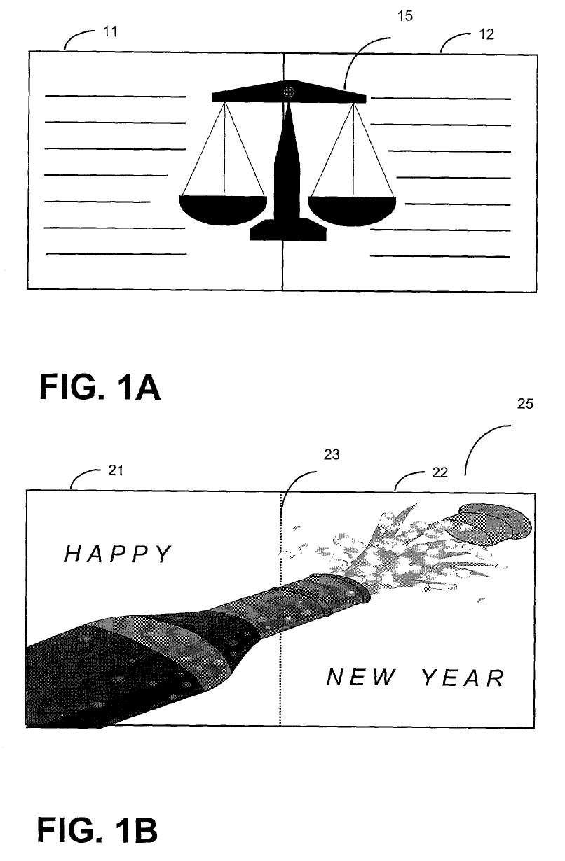

FIG. 2 is a flowchart of the flat-based workflow of a print job in the prior art;

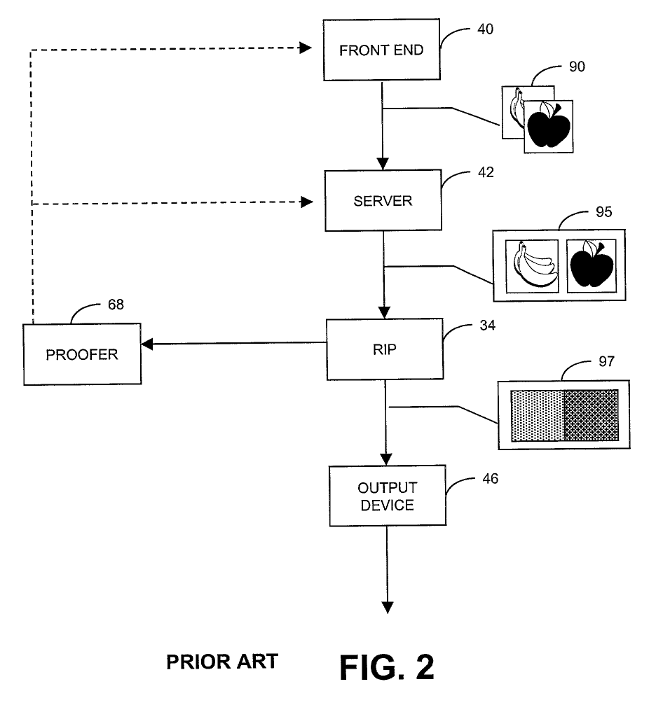

FIG. 3 is an illustration of a shingling adjustment;

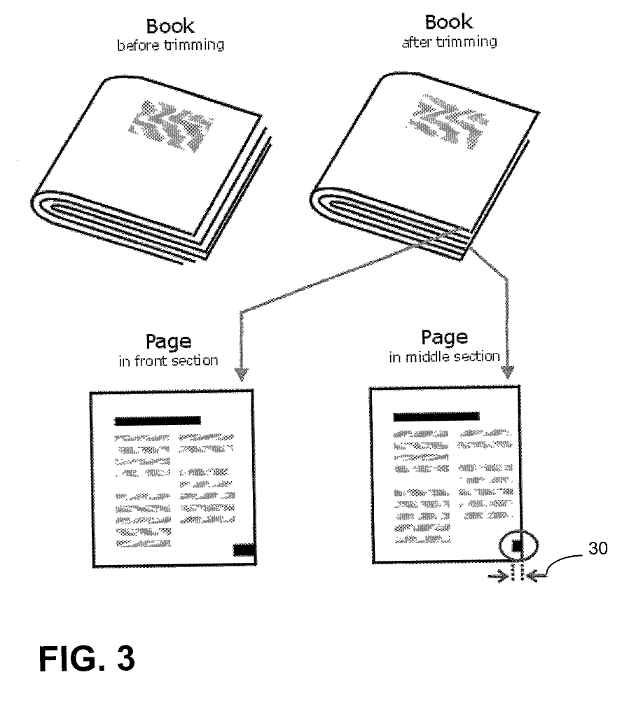

FIG. 4 is an illustration of a discontinuity between two pages of a spread, which were RIP-processed individually;

FIG. 5 is an embodiment of a prepress imaging system according to the present invention;

FIG. 6 is a flowchart of the page-based workflow of a print job in the prepress imaging system of FIG. 5;

FIG. 7 is an illustration of how to combine two pages into a two-page spread in QuarkExpress™.

FIG. 8 is an illustration of how to enlarge the paper width to fit a two-page spread in QuarkExpress™.

FIG. 9 is an illustration of the spread produced by the method of the present invention;

FIG. 10 is a list of page imposition parameters;

FIG. 11 is a list of press sheet imposition parameters;

FIG. 12 is a demonstrative example of another embodiment of the method of the present invention;

FIG. 13 is a more detailed embodiment of a print drive according to an embodiment of the invention.

### DESCRIPTION

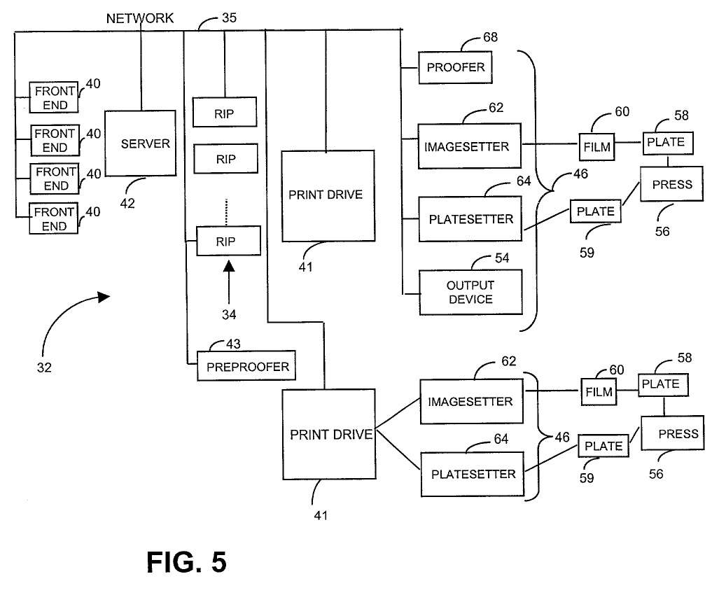

Referring to FIG. 5, a prepress system 32 for processing print jobs prior to printing, includes one or more front ends 40 connected to computer network 35. The network 35 can be any of the various types of commercially available computer networks, but must be of sufficient capacity to handle the print job traffic generated by the prepress system. In one embodiment, the network is an ethernet network, including a 100 base T switch and appropriate connections between the networked components and the switch.

The front ends 40 are used for creating, editing, or otherwise preparing image data for printing. Image data may include graphics, text, or a combination thereof. Both color and black and white images are prepared on the front end 40 for processing by the prepress system and eventual reproduction by a printing press 56 using a printing plate 58. The front ends 40 can be commercially available computers, for example, including, but not limited to, Intel-based personal computers, or computers manufactured by Apple Computer™, Sun Microsystems™, or Silicon Graphics™, having operating systems such as Windows NT™, Mac OS™, or a version of UNIX™. The front ends 40 have imaging application software such as commercially available Quark Express™ or Adobe PageMaker™. The imaging application software produces page images coded in a page description language. In a preferred embodiment of the invention, the page layout software is Quark Express™.

The front ends 40 also have imposition software, such as Scenic Soft's Preps™ or Ultimate Technologies' Impostrip™. Other imposition software can also be used. In a preferred embodiment of the invention, the imposition software is Scenic Soft's Preps™. The imposition software generates prepress imposition data used to create an imposition layout.

The front ends 40 can output page images and prepress imposition data directly to raster image processors 34 (“RIP”). The front ends 40 can also output page images to an image server 42. In one embodiment, the image server 42 receives page images from the front ends 40 and stores them on the system. The image server 42 can queue jobs for immediate transmission to one of the RIPs 34 when a RIP 34 becomes available. The image server 42 can also store page images from the front ends 40 for later processing by RIPs 34. The image server 42 helps improve workflow efficiency by allowing front end users to output their jobs even if all of the RIPs 34 are busy. By queuing a job for the RIP 34 on the image server 42, the RIPs 34 can be kept continuously busy.

The RIPs 34 may be software RIPs operating on a computer system, which may be one of the front ends 40, or other commercially available computer system including, but not limited to, Intel-based personal computers, or computers manufactured by Apple Computer™, Sun Microsystems™, or Silicon Graphics™, having operating systems including Windows NT™, Mac OS™, or a version of UNIX™. An example of such a software RIP is the Agfa Apogee PDF RIP™ software available from Agfa Corporation of Wilmington, Mass. The RIP 34 may also be dedicated hardware RIPs. Each RIP 34 has a software and/or hardware RIP module for some RIP functions, which include, without limitation, such functions as screening, trapping, imposition, page or image combination, color separating, and color management of page image data.

Each of the RIPs 34 includes an input network interface module over which page images coded in a page description language or other types of input image files are received from the front ends 40 or the image server 42. Each RIP 34 typically appears on the network and can be accessed by any front end 40 or an image server 42 or other computer system on the network 35. The input network interface module may also serve as an output network interface module so that a single network interface connection connects each RIP 34 to the network 35. In another embodiment, a separate network connection connects each RIP 34 to a print drive 41 to maximize system performance.

A print drive 41 receives raster data from RIPs 34, and stores the rasterized page images for reproduction by output devices 46. The print drive 41 may be connected to the RIPs 34 and the output devices 46 directly, or via the network 35. As described further below, in addition to storing rasterized page images, the print drive is capable of combining portions of an image into one image. For example, the print drive can combine page images into flats. The print drive can combine page images into flats on demand as the flat is transmitted to the output device or when display of raster data is requested.

In one embodiment, print drive 41 is implemented as one or more software modules operating on a standard computer platform configured for efficient print drive functions. Typically, this would be a high-performance computer, with sufficient memory, disk space, and processing power to perform the functions described herein. In one embodiment, the print drive 41 is implemented as a server-class PC with dual 550 MHz Intel PENTIUM III processors, multiple high-speed disk drives and 256 MB of memory, but depending on the processing requirements and performance desired, machines with greater or lesser capabilities can be used. The print drive hardware may also include a number of interface boards or modules including, for example, a fast network interface or a hardware connection to an output device 46 such as an imagesetter 62, platesetter 64, or direct on-press imaging system. In other embodiments, the print drive can include other special-purpose hardware.

The output devices 46 may include any output devices which are used in a prepress system or in a printing environment, such as a printer, a print engine, a proofer, a filmsetter, an imagesetter, a platesetter, a computer-to-plate system or a direct on-press imaging system. The final output devices 46 such as the imagesetter and platesetter generate raster image data representing halftone or otherwise screened images for eventual transfer onto a film 60 or a printing plate 58 for reproduction by a printing press 56. Another example of the final output device 46 is a direct on-press imaging system, which enables processing and reproduction of raster image data directly by the press.

A proofer 68 creates images representative of the printed material, thereby allowing a system operator or a customer to verify correctness of the imposition layout and color reproduction of the final product while avoiding the costs of actually making printing plates and setting up a high-speed, high-volume, printing press to produce an example of an intended image. These images may often require several corrections and be reproduced several times to satisfy customer requirements. Examples of proofers are the AgfaJet Sherpa™ family of proofers, available from Agfa Corporation of Wilmington, Mass.

An imagesetter 62 images on photosensitive film or paper. The photosensitive film 60 is used to make at least one plate 58. A plate is used on press 56 to print one color of an image. On a black and white image, only one color, black, may be necessary. For a color image, generally at least 3 colors, cyan, magenta, and yellow, and often a fourth color, black, are used. Often one or more spot colors are used as well. The imagesetter 62 images a separation for each color onto a film, and each separation is used to make a plate 58. The plates are then used on a press to print high quality printed material, often in large quantities. Examples of imagesetters are the Agfa Selectset Avantra™ Series and the Agfa Phoenix™ Series of imagesetters, all available from Agfa Corporation of Wilmington, Mass.

A platesetter 64 images directly onto a plate 59, without the use of film 60. By use of the platesetter 64, the step of creating a plate 58 by using film 60 is eliminated. This can improve the workflow, because it eliminates a step, and also eliminates the material cost of film 60. Examples of platesetters are the Agfa Galileo™ platesetter and the Agfa Xcalibur™ digital platesetting system, available from Agfa Corporation of Wilmington, Mass.

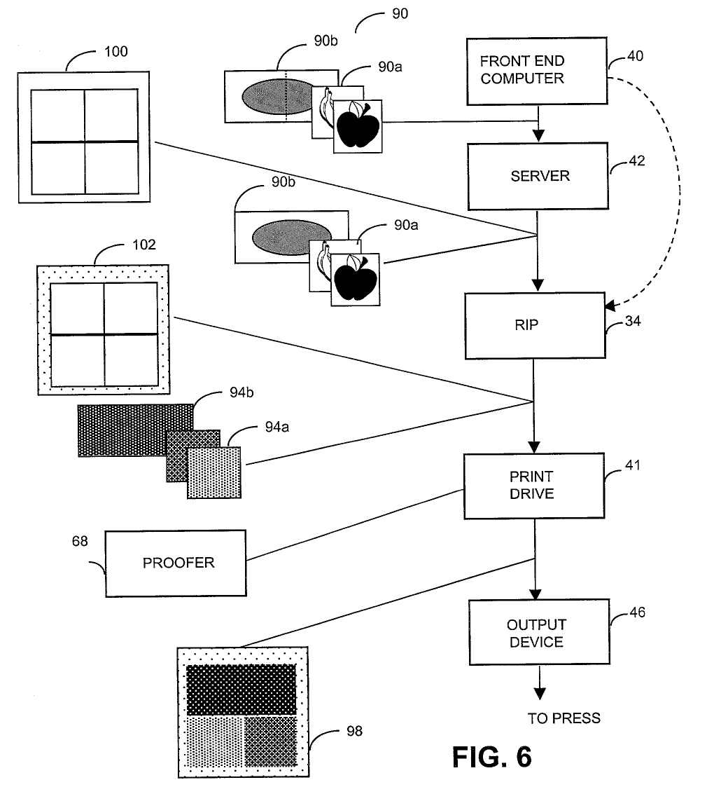

Referring to FIG. 6, in an embodiment of the invention, the workflow of the prepress system of FIG. 5 begins with the front end 40. Page images 90 of a print job are designed using imaging software and are coded in a page description language, such as PostScript or PDF. Each page image 90 may include text, graphics, or some combination derived from the same or different sources. Each page image 90 may be the text and/or graphics that will ultimately be printed on one page of paper, or may be a portion thereof, or may be the text and/or graphics that will ultimately be printed on two or more (i.e. multiple) pages, e.g. a multi-page spread. In a preferred embodiment, each page image 90a is the text, graphics, or some combination associated with one printed page, and each two-page spread image 90b is the text, graphics, or some combination associated with one two-page spread. There are, in the example shown, two page images 90a and one two-page spread image 90b associated with a 4-up flat.

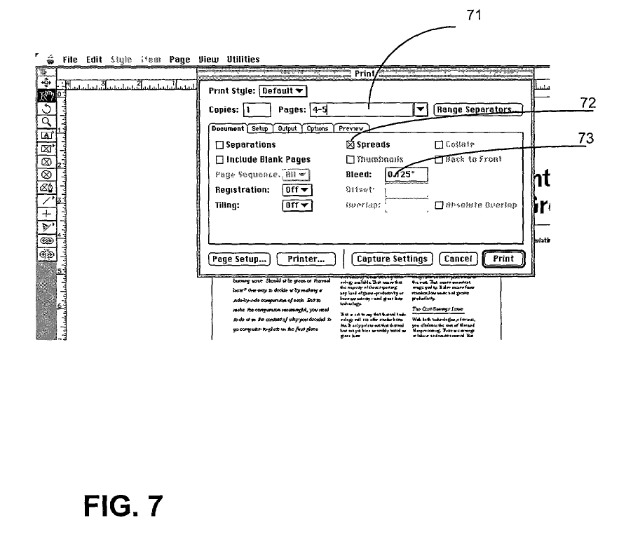

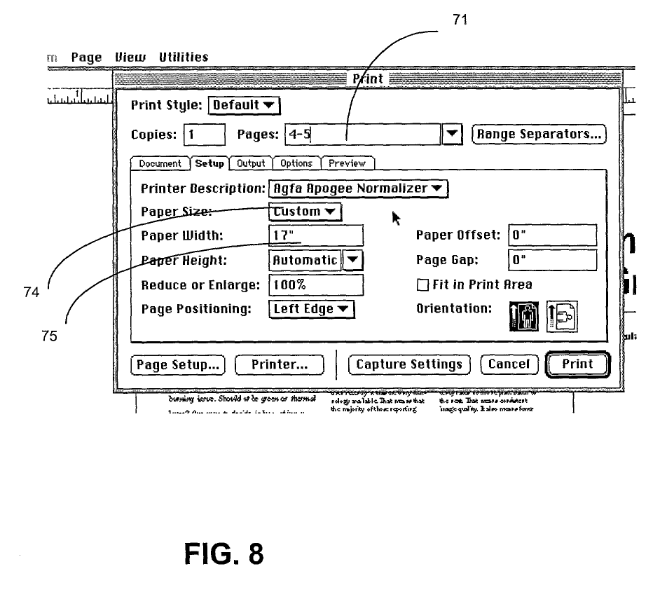

Referring to FIG. 7 two adjacent pages can be combined into a two-page spread using PRINT command in Quark Express™. To accomplish that, an operator needs to select the Document tab and then specify the component pages by page numbers in the dialog box 71, check the “Spreads” box 72, and specify the bleed parameter in the dialog box 73. It is then also necessary to enlarge media width to allow for the two-page spread. FIG. 8 shows how to implement this adjustment in Quark Express™. The operator needs to select the Setup tab and then specify in the dialog box 74 that the paper size is “custom”. The operator then needs to specify the paper width in the dialog box 75 to reflect that the spread is two-page wide. As a result, the spread image 90b is created as a single image file coded in a page description language. Alternatively, the spread may be initially created as a single image file twice the width of a single page. Using the Setup tab of PRINT command in Quark Express™, the operator will need to enlarge the media width to allow for the two-page spread as described above.

The front end 40 may queue the page images 90, including single page images 90a and spreads 90b, for processing by sending a print job to the image server 42. Alternatively, the front end 40 may output the print job directly to the RIP 34.

A set of page images 90 may be associated with a single print job by creating a job description file. For example, print job information may be specified with a job ticket editor that provides a user interface and allows for creation, editing, and tracking of job information. Print job information may be stored in a standard format, for example using Adobe's Portable Job Tickets Format (PJTF), the Job Description File (JDF) format, or another format.

The page images 90 are transmitted to the RIP 34 by either the front end 40 or the image server 42, and then processed by the RIP 34 to generate raster images 94a and 94b of each single page 90a and spread 90b respectively. Each single page 90a and spread 90b are RIP-processed separately. The RIP 34 then outputs the raster data that results from RIP-processing to the print drive 41. The print drive 41 stores the raster image 94 of each page 90 (including each multi-page image) until it is ready to be reproduced on an output device 46.

An imposition template 100 is generated using imposition application software. The imposition template 100, coded in a page description language, contains various information useful for placement of page images, including position, sequencing, orientation, bleeds, and offset data relative to the press sheet for each single page image 90a and component pages of each spread 90b to be positioned on the press sheet. Importantly, when the template is generated, the imposition application software does not impose spreads 90b as such. Rather, the software positions single page images 90a and component pages of spreads 90b in accordance with sequencing parameters of the print job. The imposition template 100 may be generated on the front end 40 or the image server 42 as a part of the print job after the page images 90 are created. Alternatively, the imposition template may also be generated in advance and independently of the print job. In one embodiment of the present invention, a standard two-sided 8-up flat workflow page template, provided in Scenic Soft's Preps™ imposition software, is utilized. The imposition software automatically selects and calculates the appropriate imposition parameters from the template, including necessary adjustments, such as bottling and shingling, to create a document containing a predetermined number of pages.

The imposition template 100 may contain position data of the press sheet relative to the type of the output device 46 and media used on the press 56. For example, separate imposition templates defining imposition schemes for the proofer 68 and the imagesetter 62 may be generated for the same print job.

The imposition template 100 is transmitted to the RIP 34 by either the front end 40 or the image server 42, and then processed by the RIP 34 to generate a press sheet template 102, which includes a set of imposition parameters used to create press sheet assembly 98 and a raster image of the imposition template 100. The RIP 34 extracts such imposition data as the position, sequencing, orientation, bleeds, and offset data relative to the press sheet for each single page image 90a and component pages of each spread 90b to be positioned on the press sheet, as well as position data of the press sheet relative to the type of the output device 46 and media used on the press 56, and generates the image of the press sheet without page images 90. The RIP 34 then transmits the press sheet template 102 and the imposition data to the print drive 41. In one embodiment, a pre-processor is included in the RIP to extract imposition data and communicate it to the print drive. Alternatively, in other embodiments, the press sheet template 102 may be generated and transmitted directly to the print drive 41 by the user, by a third party, by another device, and so on. The press sheet template 102 may then be stored on the print drive 41.

As discussed above, the imposition software typically does not provide for imposition of spreads 90b when the template 100 is generated. Instead, it accounts for the number of component pages of the spread. Because spreads 90b are RIP-processed as single image files, the number of rasterized images 94 is less than the number of pages imposed in the template. Accordingly, after RIP-processing, the imposition parameters of the press sheet template 102 must be modified prior to the output or display to position rasterized spread images 94b on the template 102 in the space provided for their respective component pages. To accomplish that, imposition parameters for the component pages are modified to form a new multi-page layout. In one embodiment, parameters, which need to be modified, include position, bleeds and offset parameters.

In one embodiment, a user interface is provided that allows a system operator to view and modify the imposition parameters. In another embodiment, the imposition parameters are stored in a text file that can be accessed by a text editor program or a word processor, and can be edited manually using such a software program. In yet another embodiment, existence of the spread in the workflow is detected by the print drive and the post-RIP modification is accomplished automatically.

After modification, the press sheet template 102 is then combined on demand with the raster images 94 to form a press sheet assembly 98. Assembling the press sheet after the page images 90 are processed by the RIP 34 permits submitting the page images 90 for processing by the RIP before the layout of the press sheet is completed. It also allows adding additional pages to the layout after the raster images 94 of these pages become available. The imposition parameters contained in the press sheet template 102 provide for accurate placement of the raster images 94 on the press sheet assembly 98. The press sheet assembly is formed on demand, at the time of imaging or display of the press sheet without first creating and storing a whole combined press sheet raster image file. The formation takes place “on the fly” at output or display time. Assembling the press sheet at the post-RIP stage increases efficiency and productivity of the prepress imaging system by substantially reducing RIP-processing time and ensuring constant engagement of the output devices and printing press.

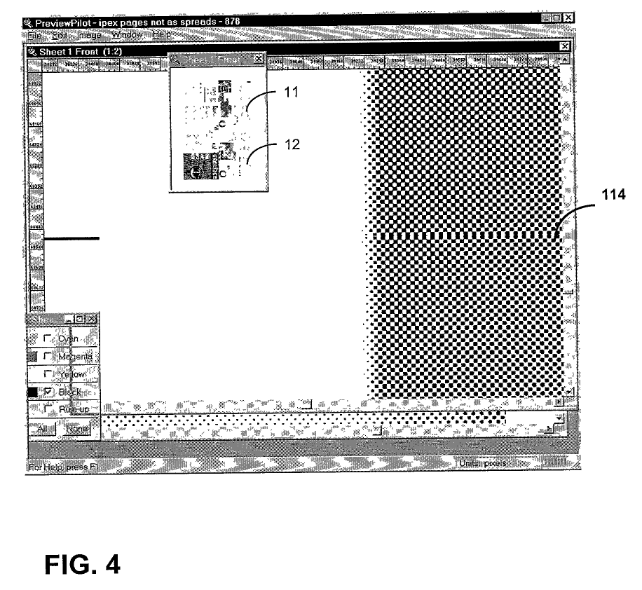

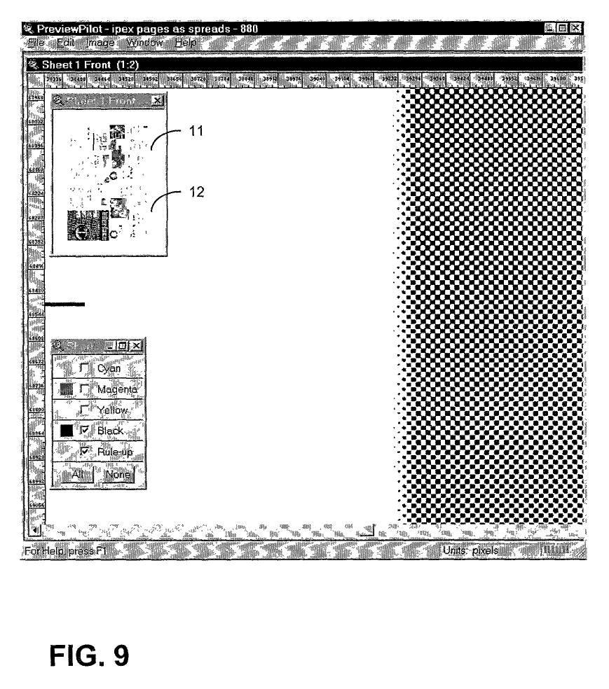

Referring again to FIG. 4, as discussed above, when the component pages 11-12 of the spread are RIP-processed individually, a visible line 114, caused by the break between the screens, may appear between the component pages 11-12 of a spread. In the present invention, however, because spreads 90b are RIP-processed as single images, the screens, used to create the image as dots of ink on the press sheet, do not become discontinuous between the component pages. Accordingly, as shown in FIG. 9., there is no undesirable visible line between the component pages 11-12 of a spread. Importantly, creation of a custom imposition template for print jobs that contain spreads is not necessary. Moreover, the present invention makes use of standard imposition templates thereby maintaining efficiency and productivity of the prepress imaging system when processing such print jobs.

When the press sheet assembly 98 is ready to be reproduced, the print drive 41 transmits the press sheet assembly 98 to an output device. In one embodiment, the print drive 41 may transmit the press sheet assembly 90 to the proofer 68. If, in such an example, no errors in the imposition scheme or color reproduction have been detected from the proofer output, the press sheet assembly 98 can be imaged to the output device 46. In another embodiment, the print drive may transmit the press sheet assembly to a high-resolution video display thereby enabling the system operator to preview the press sheet assembly 98, individual raster images 94 or the imposition template 102 prior to the reproduction. In particular, in this embodiment of the invention, the operator will be able to inspect trapping or screens. Video display preview offers the functionality disclosed therein, while avoiding expenditures of time and resources associated with producing a proof, plate or film. FIGS. 4 and 9 display high magnification view of the center spread as a part of the press sheet assembly 98 obtained using the video display preview.

If a correction or last-minute design change to the raster image 94 or the press sheet template 102 is desired, the corresponding page image 90 or the imposition template 100 can be modified and transmitted to the RIP 34 for processing. Then the raster image 94 of the modified page image 90 or the modified press sheet template 102 is transmitted to the print drive 41 where the press sheet assembly is formed on demand and provided to the proofer 68, and/or output device 46. Thus, the present invention offers significant flexibility to make late-stage changes by eliminating the need to have the RIP re-process the entire fully-imposed press sheet.

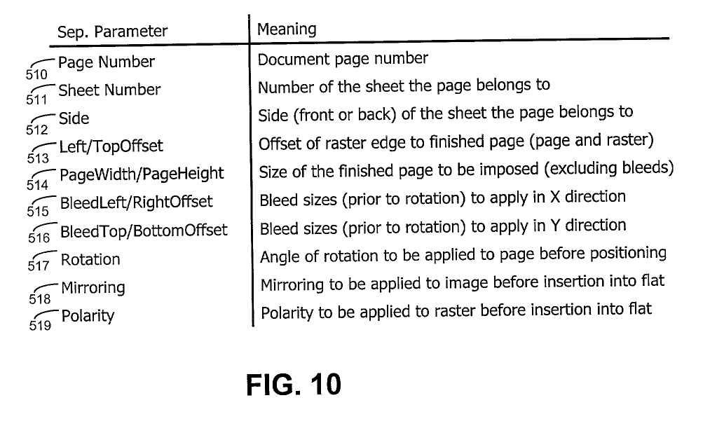

Referring to FIG. 10, the list of page imposition parameters includes the page number 510, which is the document page number. The sheet number 511 is the number of the press sheet that the page belongs to. The side 512, that is front or back, of the sheet that the page belongs to is also included. The Left/TopOffset 513, which is the offset of raster edge to finished page (page and raster) is also included. The imaging parameter list also includes the PageWidth/PageHeight 514, which is the size of the finished page to be imposed, excluding bleeds. The BleedLeft/RightOffset 515 are the bleed sizes prior to any image rotation to apply in the X direction (i.e. horizontal). The BleedTop/BottomOffset 516 are the bleed sizes prior to any image rotation to apply in the Y direction (i.e. vertical). The Rotation 517 is the angle of rotation to apply to the page before positioning. The imaging parameter list also includes mirroring 518, which is the mirroring to be applied to the image (if any) before insertion into a press sheet. The imaging parameter list also includes the polarity 519, which is the polarity to be applied to the raster before insertion into the press sheet.

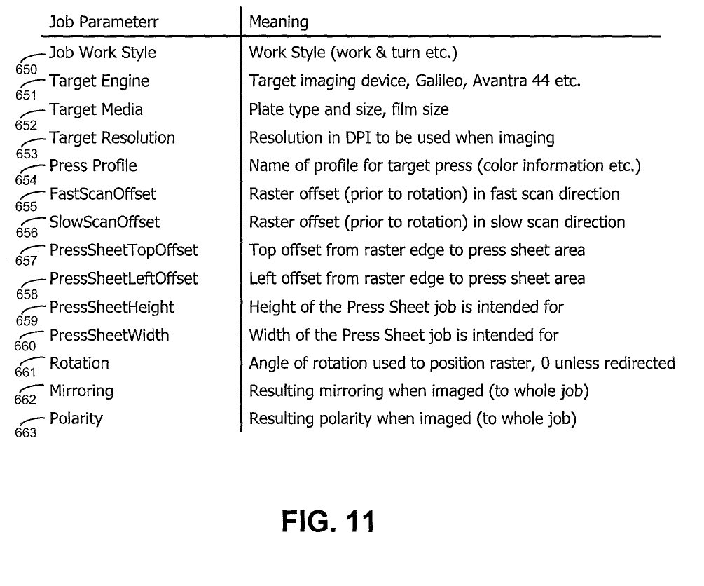

Referring to FIG. 11, imposition of the print job also requires defining the location of the press sheet assembly on target media, i.e. the press plate or film used for making the press plate. To position the press sheet onto the target media, the press sheet size and orientation, offsets and image operations, such as mirroring or negative polarity are included in the template information. The press sheet to media imposition allows users to select a different target media, such as a proofer, imagesetter or platesetter, without having to re-process the print job by the RIP or change the press sheet assembly imposition. Moreover, in one embodiment, the system operator can easily create a convenient proofing template for every print job, for example, a 2-up press sheet, referred to as a “reader's spread.”

Press sheet parameters define the imposition of the press sheet onto the output device. The list of press sheet parameters includes the job work style 650. The target engine 651 defines the target output device, such as imagesetter or platesetter. The target media 652 defines the type of the target media, such as plate or film, and its size. The target resolution 653 is the resolution used when imaging, measured in dots per inch. The press profile 654 defines the color information and other information for the particular target press. The FastScanOffset 655 defines a raster offset prior to rotation in fast scan direction. The SlowScanOffset 656 is a raster offset prior to rotation in slow scan direction. The PressSheetTopOffset 657 defines a top offset from raster edge to press sheet area. PressSheetLeftOffset 658 defines a left offset from raster edge to press sheet area. The PressSheetHeight 659 and the PressSheetWidth 660 is the height and width of the press sheet used for the print job. Rotation 661 is an angle of rotation used to position the raster. The default value of the Rotation parameter is zero. The Mirroring 662 and Polarity 663 are the resulting mirroring and polarity of the press sheet when imaged.

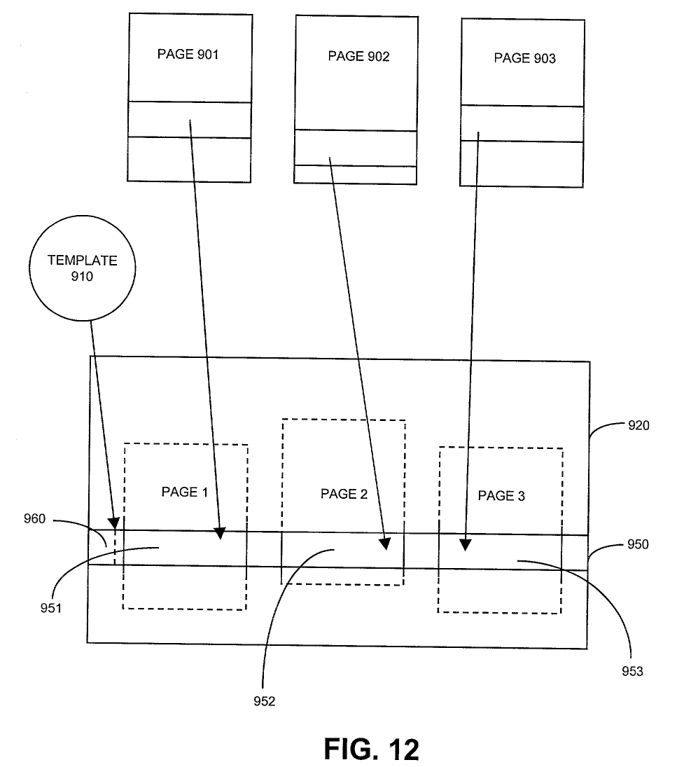

Referring to FIG. 12, a demonstrative example in which a print drive generates a portion of a press sheet for output to an output device. In this example, the portion of the data is a band to be imaged on an output device. In the press sheet of this example, there are three pages, page 901, page 902, and page 903. At the time of imaging, the print drive extracts information from these pages 901, 902, 903, and composes the band 950 (which preferably is a sufficient number of scanlines to keep the output device continuously busy) for output to the output device. The print drive uses template information 910 to determine where the portions of the pages 901, 902, 903 should be included in the band. The print drive, for example, in the generation of the band shown 950, extracts the portion 951 of page 901 that belongs in the band 950, and extracts the appropriate portion 952 of page 902 and extracts the appropriate portion of page 903. The print drive can also use information from the template 910, to add any marks or other information to the band. In a preferred embodiment, the band 950 of FIG. 10 is formed in memory, at time of output, such that only one or two bands are stored in memory at one time. The entire press sheet 920 is, therefore, not stored as a whole anywhere within the print drive, and is composed only in portions. In this way, the storage needs of the print drive are kept to a minimum, and the flexibility of the system is improved. The press sheet can also be formed for display on a computer monitor, for preview purposes. If the flat is being imaged on a display, the number of scanlines needed for display is extracted and can be written directly to the display memory. Alternatively, the entire flat or a portion of the flat can be generated on demand and stored in a file, for display or later output.

If the press sheet 920 is to be imaged on a proofer, the print drive, in one embodiment, composes the press sheet for the output device, and then performs the necessary transformations to output the image onto the proofer. Such transformations may include descreening and combining different color rasters of the same page 901, 902, 903 into contone data. See, for example, co-pending U.S. patent application Ser. No. 09/090,072 to Azima et al., filed Jun. 3, 1998, incorporated herein by reference, for a description of the transformations that may be used to process data rasterized for an output device to a proofer. The print drive can use template information to add additional marks to the band 950, for example, rule-ups that clearly show the bleed areas, and instantly show the operator whether the pages have been placed appropriately on the press sheet.

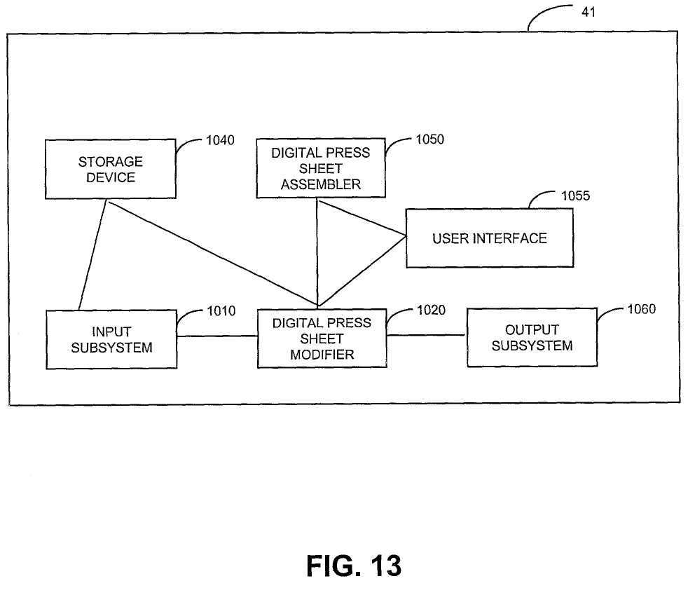

Referring to FIG. 13, a print drive 41 of the present invention includes an input subsystem 1010 for receiving page raster data of at least one of the pages of a print job, and for receiving a press sheet template. In one embodiment, the input subsystem can be implemented with networking hardware and software that allows the print drive to receive template information and raster data.

The print drive 41 further includes a digital press sheet modifier 1020 connected to the input subsystem. The digital press sheet modifier 1020 modifies the press sheet template by modifying the position, bleeds and offset parameters for the predetermined number of adjacent pages. In one embodiment, the modifier 1020 is implemented by software modules that perform the functionality described herein. In another embodiment, the modifier 1020 is implemented with some combination of special-purpose hardware and software.

The print drive 41 further includes a digital press sheet assembler 1050 connected to the digital press sheet modifier 1020. The digital press sheet assembler 1050 digitally applies the modified press sheet template to the raster data of individual pages and multi-page spreads on demand to form a press sheet assembly. In one embodiment, the assembler 1050 is implemented by software modules that perform the functionality described herein. In another embodiment, the assembler 1050 is implemented with some combination of special-purpose hardware and software.

The modifier 1020 and the assembler 1050 may include a user interface 1055. The user interface 1055 enables the system operator to view and modify the imposition templates, as well as to apply the templates to the raster data of individual pages and multi-page spreads. In one embodiment, the interface 1055 is implemented with some combination of special-purpose hardware and software modules that perform the functionality described herein.

The print drive 41 may further include a storage device 1040 connected to the digital press sheet modifier 1020. The storage device 1040 is capable of storing a plurality of the press sheet templates. In one embodiment, the storage device 1040 is a combination of hardware, such as a hard disk, RAM memory, or some combination, and software for providing data storage functions.

The print drive 41 may also include an output subsystem 1060 for transmitting data to an output device, a video display, and so on. The output subsystem 1060 may be some combination of a network device (possibly even the same network device as the input subsystem) and software to interface with the network device. The output subsystem 1060 may include hardware to interface directly with an output device.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method for imaging multi-page spreads, comprising:
receiving multi-page spread raster data of at least one of the multi-page spreads of a print job from a raster image processor, the multi-page spread raster data processed by the raster image processor as a single file;
receiving a press sheet template, the press sheet template comprising prepress imposition data;
modifying the press sheet template to accommodate the multi-page spread raster data; and
digitally applying the modified press sheet template to the multi-page spread raster data on demand to form a press sheet assembly.

2. The method of claim 1, further comprising, prior to the step of receiving a press sheet template, the steps of:
receiving prepress imposition data from an imposition generator, the prepress imposition data comprising position, sequencing, orientation, bleeds, and offset parameters for at least the number of individual pages comprising the multi-page spread to be positioned on a press sheet and further comprising press sheet imposition parameters;
extracting the position, sequencing, orientation, bleeds, and offset parameters, and the press sheet imposition parameters from the prepress imposition data; and
producing the press sheet template from the prepress imposition data.

3. The method of claim 2, wherein the step of modifying the press sheet template comprises modifying the position, bleeds and offset parameters for the predetermined number of adjacent pages.

4. The method of claim 3, wherein the predetermined number of adjacent pages is the number of pages of at least one of the multi-page spreads.

5. The method of claim 4, wherein the step of digitally applying the modified press sheet template further comprises digitally applying the modified press sheet template to raster data of other pages of the print job.

6. The method of claim 1, wherein the method further comprises, prior to the step of receiving multi-page spread raster data, the steps of:
creating a multi-page spread image file coded in a page description language;
receiving by the raster image processor the multi-page spread image file;
interpreting by the raster image processor the multi-page spread image file to produce the multi-page spread raster data; and
transmitting by the raster image processor the multi-page spread raster data.

7. The method of claim 1, further comprising the step of rendering the press sheet assembly to a destination device.

8. The method of claim 7, wherein the destination device is selected from a group consisting of:
a platesetter for imaging onto a plate;
an imagesetter for imaging onto photosensitive paper and film;
a printer for imaging onto plain paper;
a storage medium for storing a file, and
a direct on-press imaging system for imaging onto a press.

9. A print drive, comprising:
an input subsystem for receiving multi-page spread raster data of at least one of the multi-page spreads of a print job, the multi-page spread raster data processed by a raster image processor, and for receiving a press sheet template, the press sheet template comprising prepress imposition data;
a digital press sheet modifier in communication with the input subsystem and the data store; the digital press sheet modifier digitally modifying the press sheet template to accommodate the multi-page raster data; and
a digital press sheet assembler in communication with the digital press sheet modifier; the digital press sheet assembler digitally applying the modified press sheet template to the multi-page raster data on demand to form a press sheet assembly.

10. The print drive of claim 9, wherein the digital press sheet assembler, in addition to digitally applying the modified press sheet template to the multi-page raster data, further applies the modified press sheet template to raster data of other pages of the print job to form a press sheet assembly on demand.

11. The print drive of claim 9, wherein the input subsystem receives the press sheet template from a raster image processor.

12. The print drive of claim 9, further comprising:
a data store in communication with the input subsystem for storing the received press sheet template and the multi-page spread raster data.

13. The print drive of claim 9, further comprising:
an output subsystem in communication with the digital press sheet assembler, the output terminal capable of transmitting the press sheet assembly to a destination device.

14. The print drive system of claim 13, wherein the destination device is selected from a group consisting of:
a platesetter for imaging onto a plate;
an imagesetter for imaging onto photosensitive paper and film;
a printer for imaging onto plain paper;
a storage medium for storing a file, and
a direct on-press imaging system for imaging onto a press.

15. An imaging system, comprising:
a page generator for creating at least one of the multi-page spread files of a print job;
an imposition generator for creating prepress imposition data; the prepress imposition data comprising position, sequencing, orientation, bleeds, and offset parameters for at least one page to be positioned on a press sheet and further comprising press sheet imposition parameters;
a raster image processor in electrical communication with the page generator, the raster image processor processing the multi-page spread file to produce multi-page spread raster data; and
a print drive in electrical communication with the raster image processor, the print drive comprising:
an input subsystem for receiving multi-page spread raster data of at least one of the multi-page spreads of a print job, the multi-page spread raster data processed by a raster image processor, and for receiving a press sheet template, the press sheet template comprising prepress imposition data; and
a digital press sheet modifier in communication with the input subsystem; the digital press sheet modifier digitally modifying the press sheet template to accommodate the multi-page raster data; and
a digital press sheet assembler in communication with the digital press sheet modifier; the digital press sheet assembler digitally applying the modified press sheet template to the multi-page raster data on demand to form a press sheet assembly.

16. The imaging system of claim 15, wherein the digital press sheet assembler, in addition to digitally applying the modified press sheet template to the multi-page raster data, further applies the modified press sheet template to raster data of other pages of the print job to form a press sheet assembly on demand.

17. The imaging system of claim 15, further comprising a destination device in electrical communication with the print drive, the destination device is selected from a group consisting of:
a platesetter for imaging onto a plate;
an imagesetter for imaging onto photosensitive paper and film;
a printer for imaging onto plain paper;
a storage medium for storing a file, and
a direct on-press imaging system for imaging onto a press.

18. The imaging system of claim 17, wherein the print drive further comprises an output subsystem in communication with the digital press sheet assembler, the output subsystem capable of transmitting the press sheet assembly to the destination device.
